(19) United States
(12) Patent Application Publication
(10) Pub. No.: US 2005/0199103 A1
(43) Pub. Date: Sep. 15, 2005

(54) Open end supply line wrench

(76) Inventors: Lewis Quinten Thompson, Imperial Beach, CA (US); Maria Azucena Thompson, Imperial Beach, CA (US)

Correspondence Address: Lewis Q Thompson;Apt # 11, 1211 Donax Avenue, Imperial Beach, CA, 91932, US

(21) Appl. No.: 10/797,539

(22) Filed: Mar. 11, 2004

(51) Int. Cl. B25B 13/00

(52) U.S. Cl. 81/124.2

(57) ABSTRACT

A tool is provided for installing a faucet water supply tube nut on a faucet assembly at the underside of a faucet lavatory by manually seating the supply tube nut securely inside the hexagonal socket at either end of the tool alignning the supply tube nut with the lavatory faucet supply nipple and turning the tool 360 degrees tightening or loosening the nut and then sliding the tool down the supply tube to the water supply riser nut and seating the tool on the riser nut and aligning the riser nut with the threaded riser nipple of the angular shut off valve and is again turned 360 degrees until fully tightened or loosened depending on the need of the user.

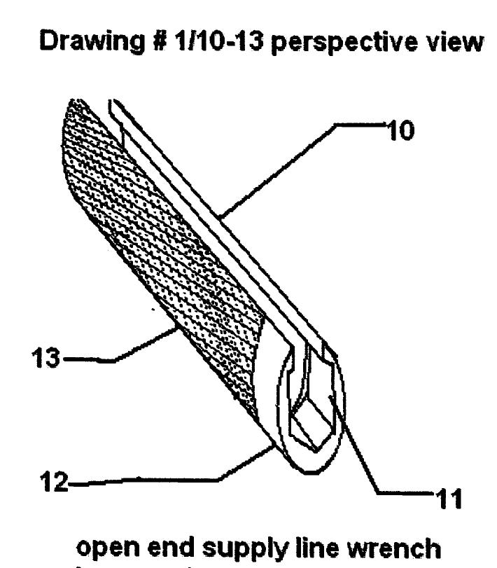

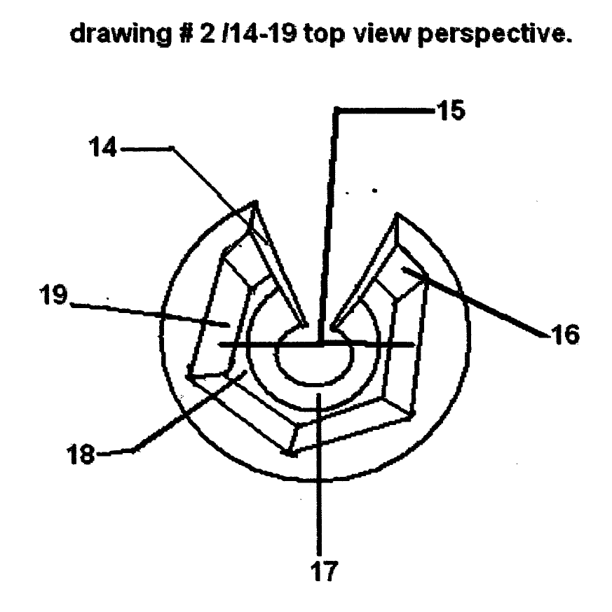

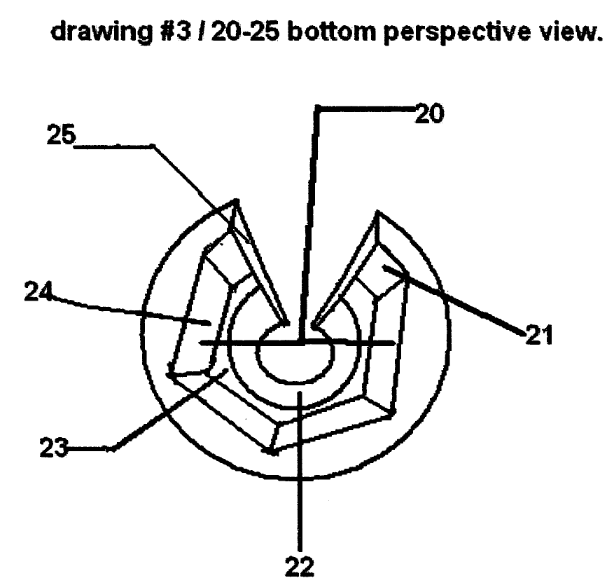

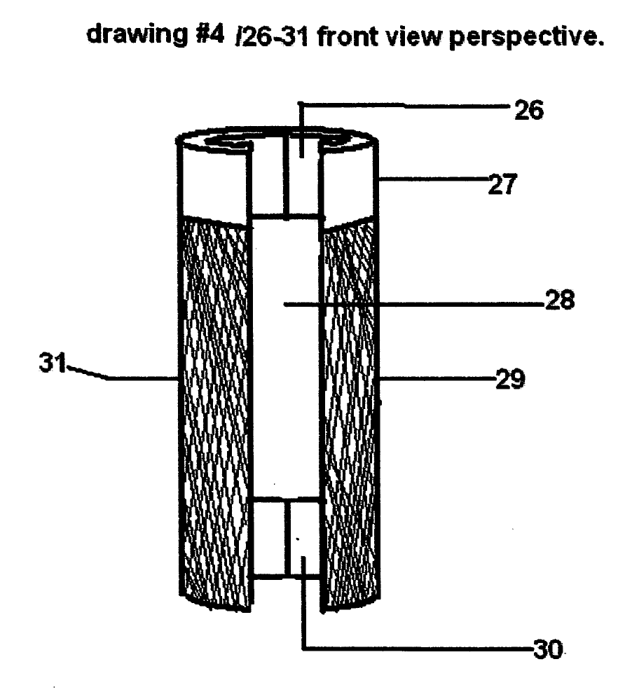

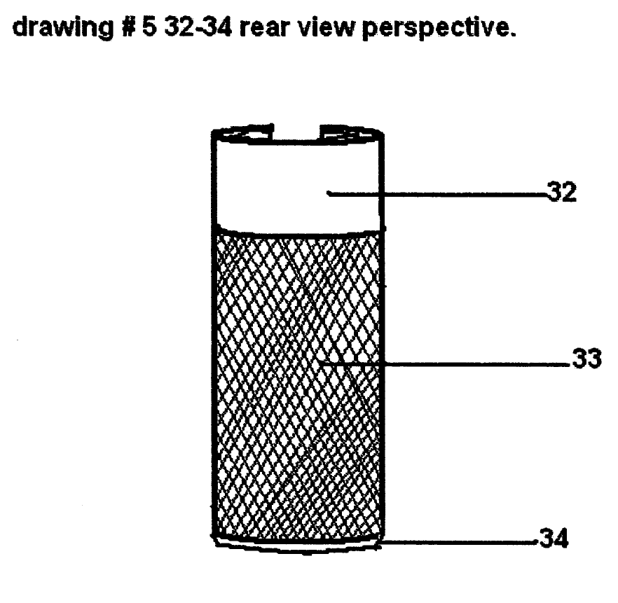

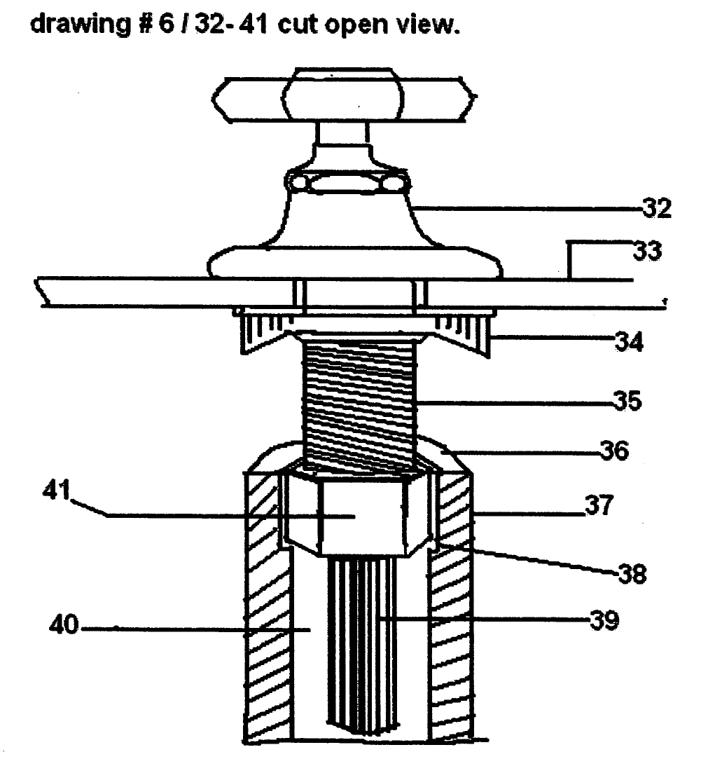

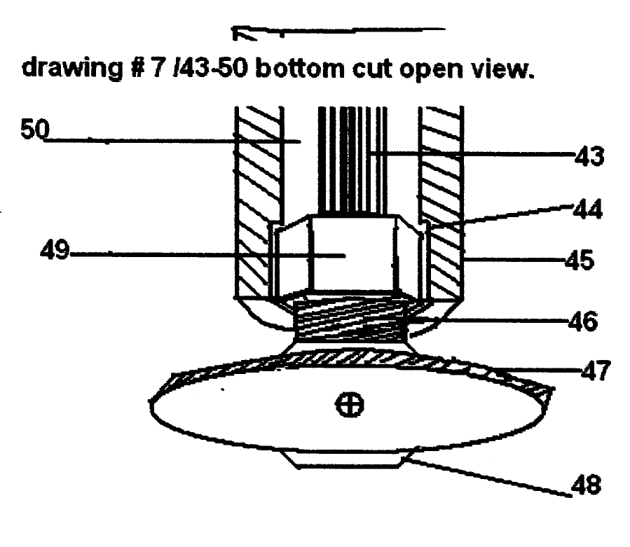

### SPECIFICATIONS

1. Hollow tube of aluminum alloy machined on a lathe to 34 millimeters in width
2. Center is bored out to 22 millimeters in width.
3. Tube is cut to 125 millimeters in height.
4. Top hexagonal opening walls are 13 millimeters in height.
5. Top 4 interior hexagonal walls are 13 millimeters in width.
6. Top 2 outer small hexagonal walls are 4 millimeters in width after milling.
7. Tubing has an opening milled that is 17 millimeters in width and 125 millimeters in height.
8. Top of outer tubing has a polished finish that is 22 millimeters in height.
9. Immediately following the polished finish are perforations that continue for 103 millimeters.
10. The perpendicular width between the top hexagonal opening walls is 24 millimeters.
11. The bottom hexagonal opening walls are 13 millimeters in height.
12. The bottom 4 hexagonal walls are 13 millimeters in width.
13. The 2 bottom outer smaller hexagonal opening walls are 4 millimeters in width.

14. The perpendicular width between the bottom hexagonal walls is 24 millimeters.

References Cited

| | | | |
|---|---|---|---|
| 3071995 | January, 1963 | Ruthrauff, Jr. | 81/124. |
| 3086414 | April, 1963 | Nardi | 81/124. |
| 3151512 | October, 1964 | Charczenco | |
| 3578046 | November, 1971 | Curran | |
| 4291429 | September, 1981 | Servadio | |
| 4357845 | November, 1982 | Cornea | 81/124 |
| 4450919 | May, 1984 | Cousineau | |
| 4466315 | August, 1984 | Boschetto, Jr. et al | |
| 458770 | May, 1986 | Lindberg | |
| 4818157 | April, 1989 | Kouvelis | |
| 4823650 | April, 1989 | Tuttle | 81/124 |
| 300145 | June, 1884 | Simon | |
| 6644957 | July, 1997 | Gustafson | 81/165 |

### Other References

Plumbers Tools, Part Numbers. 749007-887015, Century Maintenance Supply Catalog; p.532-535 2003 Basin Wrench, Part number 749003

### BACKGROUND OF THE INVENTION

1. Field of the Invention

The present invention relates to a tool and method for installing faucet supply tube nuts on faucet assemblies at the underside of a lavatory and a method for installing a faucet supply tube riser nut to an angular shut off valve at the underside of a lavatory.

2. Description of the Prior Art

In conventional practice faucet assemblies secured to kitchen, bathroom and utility room lavatories or sinks by the means of a faucet nuts at the underside of a lavatory. The faucet assembly has 2 threaded nipples protruding downwardly past the faucet nut. The left threaded nipple is for a hot water supply tube connection. While the right nipple is for a cold water supply tube connection. Typically residential plumbing faucet assemblies have faucet nipples which are three quarters of an inch in nominal diameter.

To install a faucet supply tube nut to the faucet assembly according to conventional practice, a plumber lays down on his back and climbs under the lavatory to make visual contact with the faucet nipple grasping the faucet supply tube the plumber then feels his hand along the supply tube grasping the supply tube nut the plumber then lines the supply tube and nut up with the faucet assembly's threaded nipple the plumber then places the faucet supply tube nut against the faucet threaded nipple engaging the nut manually with his fingers turning the nut counter clockwise the until the threads of the nipple line up with the threads of the supply tube nut the plumber then turns the nut clockwise until the nut is as tight as possible

The plumber in order to adequately secure the faucet supply tube nut to the faucet assembly threaded nipple normally utilizes some implement to advance the faucet supply tube nut along several threads of on the faucet assembly nipple so that the rubber compression washer located inside the faucet supply tube nut will compress against the threads and base the faucet supply tube nut as well as the faucet assembly threaded nipple thus creating a water tight seal in order to do this according to conventional practices the plumber will typically employ either a basin wrench or a channel lock wrench in the final stages of tightening the supply tube nut to adequately secure it.

The present system for installing plumbing faucet supply tube nuts is quite laborious and time consuming. The plumber is forced to tediously advance the faucet supply tube nut several turns first by hand and then by use of a basin wrench or channel lock wrench of both which must be adjusted many times prior to placing them over the faucet supply tube nut with the limited tight spacing that is provided between the drain bowl of the lavatory sink and the wall advancing the channel lock or basin wrench is limited forcing the plumber to remove the channel lock or basin wrench and reset them over and over again only advancing the faucet supply tube nut ¼ to ½ of a turn at best. A plumber who must spend several hours installing a number of faucets in this manner will invariably experience considerable soreness of the fingers, shoulders or back cramps that can also occur from lying inside of a cabinet with no support. Furthermore, since manual advancement of faucet supply tube nuts proceeds so slowly, a considerable amount of the plumber's time is consumed in the process.

The nature of basin wrenches and channel lock wrenches is such that those devices require a considerable lateral area to accommodate the swing of the wrench handles in order to obtain adequate leverage to tighten a faucet supply tube nut.

Where faucet supply tubes are located in narrow spaces, as is the case, the plumber must sacrifice the leverage required for controlled tightening of the supply tube nut. Thus the plumber must attempt to undertake tightening of the faucet supply tube nut with the wrench handle varying from the axis of the faucet assembly nipple by only a few degrees. As a consequence, the leverage is very poor, thereby requiring an application of considerable strength to adequately tighten the faucet supply tube nut. Furthermore, a basin wrench or such tool is quite likely to slip off of the faucet supply tube nut or strip the outer housing of the faucet supply tube nut, or crack the housing of the supply tube nut, or strip the threads of the faucet assembly nipple due to over torquing, furthermore the fragile rubber compression washer that is located within the faucet supply tube can be over compressed causing the washer to strip thus creating a poor seal between the faucet assembly nipple and the faucet supply tube, and in any event significantly lengthens the time required to install the faucet supply tube nut.

### BRIEF SUMMARY OF THE INVENTION

According to the present invention a tool is provided which greatly facilitates the installation of a faucet assembly nipple to a faucet supply tube nut and which substantially reduces the time required for the installation. The tool is an implement adapted for hand use; the tool has a socket or barrel with as milled slot that runs the height of the tool, the socket or barrel is of a hollow, tubular configuration that has an opening big enough to fit over and encompass the depending supply tube of a faucet supply tube. The tool has 3 openings and 2 ends. The walls of 2 open ends located horizontally at the top and horizontally at the bottom of the barrel or tube are formed in a hexagonal cross section of which 6 of the walls are perpendicular to each other and of which 2 of the walls are unequal in width to the other 4 walls of which 2 of the walls perpendicular to each other are of the same width. The third opening is the milled slot that runs horizontally from the tip of the top horizontal, hexagonal opening to the bottom tip of the bottom horizontal, hexagonal opening which exposes the inside wall of the barrel or tube from top to bottom. The exterior outer skin of the barrel is perforated.

### A BRIEF DESCRIPTION OF THE DRAWINGS

1. Drawing # 1/10-13. is a perspective view of the top hexagonal opening as well as the milled opening that runs horizontally from the top of the tube or barrel to the bottom hexagonal opening as well as the perforated grip handle.

2. Drawing # 2/14-19 is the top view perspective depicting the hexagonal open end, center bore, and milled opening.

3. Drawing # 3/20-25 is the bottom view perspective depicting the 2^{nd} hexagonal open end and the milled opening. As well as the center bore.

4. Drawing # 4/26-31 is a front view perspective showing the partial center bore as well as the 2 hexagonal open ends, the top of the polished tube and the perforated grip handle, and the milled horizontal opening.

5. Drawing # 5 32-34 is the rear view perspective which depicts the perforated grip handle and the top polished end.

6 Drawing # 6/32-41 depicts the cut open view where the top of hexagonal opening is placed over a faucet supply tube nut engaged to a faucet assembly nipple.

7. Drawing # 7/43-50 depicts the bottom view of the wrench engaging the faucet supply tube riser nut.

### DETAILED DESCRIPTION OF THE INVENTION

The tool is designed to drive on a faucet supply tube nut and faucet supply tube riser nut that is adapted for engagement with the threaded nipple of a faucet that extends downwardly on the underside of a lavatory. The tool is devised so as to advance the faucet supply tube nut along the exposed length of the faucet nipple until the compression washer located inside the faucet supply tube nut compresses against the faucet nipple creating a water tight seal the process is then repeated with the riser nut located at the opposite end of the faucet supply tube.

The faucet supply tube nuts of which the tool of the invention is designed to install are internally threaded and have one basic size. Faucet supply tube nuts of the same and different manufacturers are generally the same the preferred embodiment of the tool of the invention may be utilized to quickly and firmly engage those commercially available types of faucet supply tube nuts which are most widely used, both during installation and removal.

The faucet plumbing tool of the invention greatly facilitates and speeds up the installation of faucet supply tube nuts and riser nuts according to the method of the invention. The tool is designed to be held in the palm of the left or right hand while the available free hand places a faucet supply tube through the tool's third opening cradling the faucet supply tube horizontally, and whereas the tool is then slid horizontally up the faucet supply tube to where the tool's first or top hexagonal opening encompasses the faucet supply tube nut and cradles the faucet supply tube nut firmly in place so that the faucet supply tube nut that is adapted for engagement with a faucet assembly nipple of a faucet that extends downwardly on the underside of a lavatory.

The tool is devised so as to allow the plumber convenience of needing only to kneel down facing the faucet assembly extending the arm that is grasping the tool which is in turn cradling the faucet supply tube and faucet supply tube nut, beneath the lavatory toward the direction of the faucet assembly and the faucet assembly nipple located beneath the lavatory the plumber using hand and eye coordination glances at the faucet assembly hot or cold knob that rests on top of the lavatory while bringing his hand into alignment with the faucet assembly nipple located beneath the lavatory and advance the faucet supply tube nut along the exposed length of the faucet nipple located at the underside of the lavatory, and to advance the faucet supply tube nut until the faucet supply tube nut is firmly tightened to the point that the faucet supply tube nut can advance no further.

The plumber can then slide the tool horizontally down the supply tube to the riser nut where the plumber can then place the bottom opening of the tool over the riser nut and align the nut with the threaded nipple of the angular shut off valve and turning the tool clockwise until the supply tube riser nut compression washer compresses against the threaded nipple creating a water tight seal. The plumber then lifts the tool away from the supply tube, and process is repeated for the second faucet supply tube.

In one broad aspect the present invention may be considered to be a plumbing tool for installing a faucet supply tube nut on a threaded nipple of a faucet assembly. The plumbing tool is comprised of a tube or barrel having two hexagonal openings located at the top and bottom end of the barrel and a third opening that runs horizontally from the top hexagonal opening to the bottom hexagonal opening. The milled opening exposes the full center of the barrel and is wide enough to circumscribe a supply tube, while the hexagonal socket openings are formed by six walls of which four of the six walls are equal in height and width while the last two walls are roughly ⅓ the width of the other four walls but are equal in height. The outer skin of the barrel has perforations which serve as a grip for holding the tool firmly.

In the preferred embodiment of the invention the walls of the hexagonal openings are 12.5 millimeters wide and perpendicular by 24 millimeters the height of the walls of the hexagonal openings are 13 millimeters with a ledge designed to hold the base of the faucet supply tube nut. The milled slotted opening that runs the horizontal length of the tool is 17 millimeters in width and is 125 millimeters in length. The tool is constructed of such a size is able to accommodate the most widely employed faucet supply tube nuts which are utilized in residential faucet plumbing installations.

A further preferred feature of the plumbing tool of the invention is the perforations on the outer body of the barrel or tube this feature allows the plumber added control with a surface unlikely to slip during usage; it also allows the plumber to be able to apply adequate torque during loosening and tightening procedure.

The invention may be described with greater clarity and particularity by reference to the accompanying drawings.

### DESCRIPTION OF THE DRAWINGS INCLUDES 7 DRAWINGS

Drawing. # 1/10-13. is a perspective drawing of a tool constructed according to the invention.
1/10 is the OPEN milled slot that runs the horizontal length of the tool
1/11 is the top hexagonal opening.
1/12 is the polished top of the tool.
1/13 shows the perforated grip handle.

Drawing. #2/14-19. is the view of the tool from a top view perspective of the invention.
2/14 is the top view perspective of the milled slot.
2/15 is the top view perspective of 2 hexagonal walls perpendicular to each other.
2/16 is the top view perspective of the smaller of the hexagonal walls.
2/17 is the top view perspective of the center bore.
2/18 is the top view perspective of the ledge beneath the hexagonal walls.
2/19 is the top view perspective 1 of the 4 hexagonal walls equal in height and width.

Drawing #3/20-25 is the view of the tool from a bottom view perspective of the invention.
3/20 is the bottom view perspective of the 2 hexagonal walls perpendicular to each other.
3/21 is the bottom view perspective of the smaller the 6 hexagonal walls.
3/22 is the bottom view perspective of the center bore.
3/23 is the bottom view perspective of the ledge beneath the hexagonal walls.
3/24 is the bottom view perspective of 1 of 4 hexagonal walls equal in height and width.
3/25 is the bottom view perspective of the open milled slot that runs the horizontal length of the tool.

Drawing # 4/26-31 is a front view perspective of the tool of the invention.
4/26 is the front view of the top hexagonal socket walls at the top OPEN END.
4/27 is the front view of the top imperforated polished outer wall.
4/28 is the front view of the center bore.
4/29 is the front view of the right side of the perforated grip handle.
4/30 is front view of the bottom hexagonal OPEN END
4/31 is the front view of the left side of the perforated grip handle.

Drawing # 5 32-34 is the rear view perspective of the tool of the invention.
5 32 is the rear view perspective of the polished imperforated top of the tool.
5 33 is the rear view perspective of the perforated grip handle.
5 34 is the rear view perspective of the base of the tool

Drawing # 6/32-41 is the top cut open view illustrating the tool of the invention in use
6/32 is the faucet housing located above the lavatory.
6/33 is the lavatory base.
6/34 is the faucet rosette nut.
6/35 is the faucet assembly threaded nipple.
6/36 is the top of the tool of the invention
6/37 is the outer housing of the tool of the invention.
6/38 is the inner view of the hexagonal wall of the tool of the invention.
6/39 is the front view of the faucet supply tube.
6/40 is the view of the inner bore of the tool of the invention.
6/41 is the faucet supply tube nut engaging the faucet assembly nipple.

Drawing # 7/43-50 is the bottom cut open view of the tool of the invention in use.
7/43 is the bottom of the faucet supply tube.
7/44 is the bottom OPEN END of the tool of the invention hexagonal wall.
7/45 is the bottom view of the outer housing of the tool of the invention.
7/46 is the top of the threaded riser nipple of the angular shut off valve.
7/47 is the front view of shut off handle of the angular shut off valve.
7/49 is the faucet supply tube riser nut.
7/50 is the bottom view or the center bore of the tool of the invention.

1. A plumbing tool for installing a faucet water supply tube nut to a faucet assembley, and a riser nut to an angular supply valve, comprising a hexagonal socket at the top end and a hexagonal socket at the bottom end and a milled opening that runs the length of the wrench housing for cradling a supply tube line and engaging both the faucet and riser nuts, a standard supply tube nut of twenty-two millimeters in width is held in position by six walls of which each wall is perpendicular of each other are separated by a distance of twenty-four millimeters of which four are of equal length and two walls that are equal in length to each other but are only one-third the width of the primary four walls with perforations located on the outer surface of the tool body used for gripping.

2. A plumbing tool according to claim 1 wherein said walls within each pair of walls are perpendicular of each other are separated by a distance of twenty-four millimeters.

3. A plumbing tool according to claim 1 wherein said one hexagonal socket at the top end which is twelve millimeters in depth.

4. A plumbing tool according to claim 1 wherein said hexagonal socket located at the bottom end which is twelve millimeters in depth.

5. A plumbing tool according to claim 1 wherein said walls of milled opening are perpendicular with a distance of seventeen millimeters.

6. A plumbing tool according to claim 1 wherein said wall of hexagonal socket at the top end has four equal walls fifteen millimeters in width.

7. A plumbing tool according to claim 1 wherein said walls of hexagonal socket at the top end has two equal walls five millimeters in width.

8. A plumbing tool according to claim 1 wherein said walls of hexagonal socket at the bottom end has four equal walls fifteen millimeters in width.

9. A plumbing tool according to claim 1 wherein said walls of hexagonal socket at the bottom end has two equal walls five millimeters in width.

10. A plumbing tool according to claim 1 wherein said external housing is perforated from bottom of base and extending ten centimeters and a polished finish completing the last 2.3 centimeters.

11. A plumbing tool according to claim 1 for securing a faucet supply tube nut onto a faucet assembley and supply tube riser nut to an angular shut off valve.

12. A plumbing tool according to claim 1 wherein there are two hexagonal OPEN ENDS perpendicular to each other.

13. A plumbing tool according to claim 12 wherein the hexagonal end openings are ten centimeters apart.
